(19) United States
(12) Patent Application Publication
(10) Pub. No.: US 2017/0139989 A1
(43) Pub. Date: May 18, 2017

(54) Pruning of Table Partitions from a Calculation Scenario for Executing a Query

(71) Applicant: SAP SE, Walldorf (DE)

(72) Inventors: Christoph Weyerhaeuser, Heidelberg (DE); Tobias Mindnich, Sulzbach (DE); Johannes Merx, Heidelberg (DE); Julian Schwing, Mannheim (DE)

(21) Appl. No.: 14/945,207

(22) Filed: Nov. 18, 2015

(51) Int. Cl. G06F 17/30

(52) U.S. Cl. CPC G06F 17/30454; G06F 17/30486; G06F 17/30469

(57) ABSTRACT

A calculation engine of a database management system receives a calculation scenario. The calculation scenario comprises a query of a multiprovider that comprises a plurality of partitions. The calculation engine evaluates the query to identify a partition of the plurality of partitions that is not necessary for responding to the query. The calculation engine prunes the partition from the calculation scenario. The pruning comprises not loading or accessing the partition in the execution of the query and/or removing the filter constraint for the partition.

### TECHNICAL FIELD

The subject matter described herein relates to pruning of table partitions from a calculation scenario for executing a query.

### BACKGROUND

Calculation scenarios usually consist of a plurality of multiproviders. A multiprovider is a special operation combined with an aggregation function and enhanced column mapping information. The multiprovider aggregates a plurality of partproviders for data. A partprovider is a semantic table partition that holds data (e.g., data for a specific accounting year or a specific account region). Often, in calculation scenarios, queries consist of more than one multiproviders that are stacked on top of each other. Thus, the partproviders belonging to the lower multiproviders are aggregated multiple times creating redundancy and unnecessary slowdown of the queries.

### SUMMARY

A calculation engine of a database management system receives a calculation scenario. The calculation scenario includes a query of a multiprovider that has a plurality partitions. The calculation engine evaluates the query to identify a partition of the plurality of partitions that is not necessary for responding to the query. The evaluating may be comparing a mapping value of the partition to a filter constraint. The calculation engine prunes the partition from the calculation scenario. The pruning includes not loading or accessing the partition in the execution of the query and/or removing the filter constraint for the partition.

The calculation scenarios include a plurality of queries.

The comparing a mapping value of the partition to a filter constraint includes determining the mapping value having a constant value that is out of range specified in the filter constrain of the query.

The filter constraint is removed if the result of the comparing is always true.

The partition is not necessary if the result if the result of the comparing is always false.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, with the current subject matter, new software for database can be deployed in parallel to old software while, at the same time, as much persistency as possible is reused. Such an arrangement provides for an in-place upgrade in which, if the upgrade writes to persistency, either due to content delivery or due to data migration activities, the data for the respective database tables is duplicated. This approach minimizes the additional memory consumption during the upgrade procedure as compared to conventional techniques for upgrading database software with little, if any, downtime.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a computer architecture including a database system that includes three layers;

FIG. 2 is a diagram illustrating a sample architecture for request processing and execution control;

FIG. 3 is a diagram that illustrates an unoptimized model of a calculation scenario;

FIG. 4 is a diagram that illustrates an optimized model of a calculation scenario;

FIG. 5 is a process flow diagram illustrating a method of pruning of table partitions from a calculation scenario for executing a query.

Like reference symbols in the various drawings indicate like elements.

### DETAILED DESCRIPTION

The current subject matter is directed to identifying unnecessary partitions and pruning the unnecessary partitions from a calculation scenario to avoid unnecessary partitions and speed up processing time.

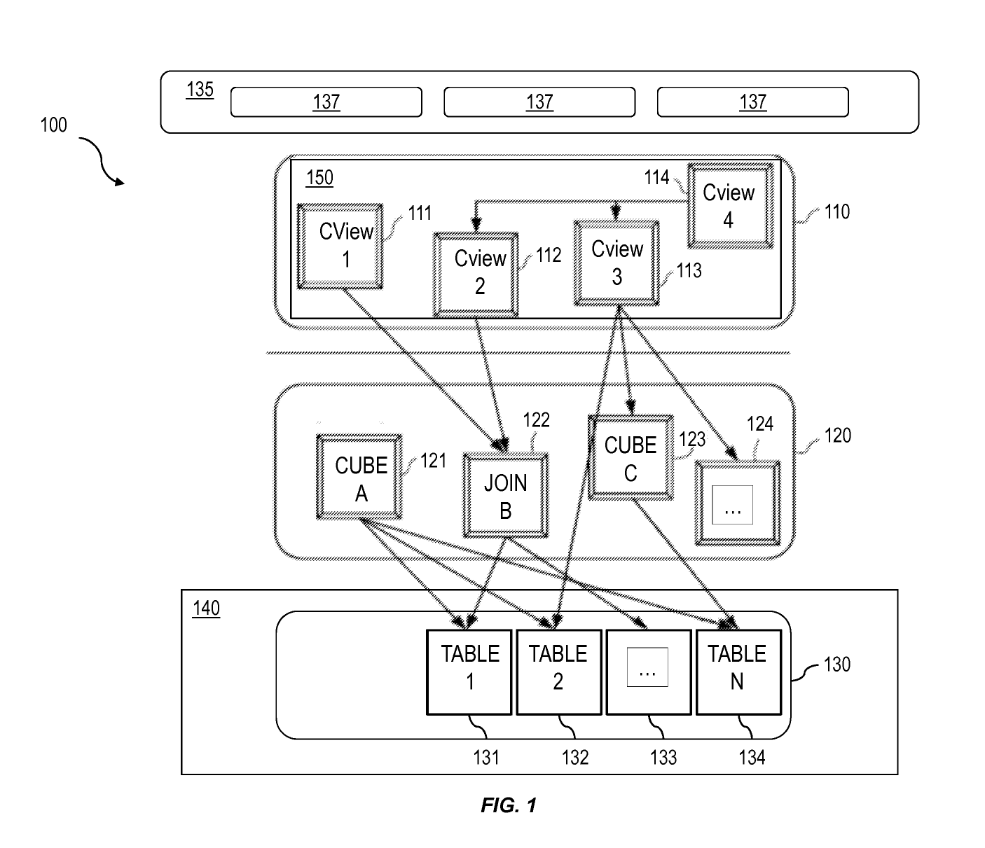

FIG. 1 is a diagram that illustrates a computing architecture 110 including a database system that includes three layers: a calculation engine layer 110, a logical layer 120, and a physical table-pool 130. One or more application servers 135 implementing database client applications 137 can access the database system 200. Calculation scenarios can be executed by a calculation engine, which can form part of a database or which can be part of the calculation engine layer 110 (which is associated with the database). The calculation engine layer 110 can be based on and/or interact with the other two layers, the logical layer 120 and the physical table pool 130. The basis of the physical table pool 130 consists of physical tables (called indexes) containing the data, which can be stored on one more database servers 140. Various tables 131-134 can be joined using logical metamodels 121-124 defined by the logical layer 120 to form an index. For example, the tables 131-134 in a cube (e.g. an online analytical processing or “OLAP” index) can be assigned roles (e.g., fact or dimension tables) and joined to form a star schema. It is also possible to form join indexes (e.g. join index B 122 in FIG. 1), which can act like database views in computing environments such as the Fast Search Infrastructure (FSI) available from SAP SE of Walldorf, Germany.

As stated above, a calculation scenario 150 can include individual nodes (e.g. calculation nodes) 111-114, which in turn each define operations such as joining various physical or logical indexes and other calculation nodes (e.g., CView 4 is a join of CView 2 and CView 3). That is, the input for a node 111-114 can be one or more physical, join, or OLAP indexes or calculation nodes.

In a calculation scenario 150, two different representations can be provided, including a) a pure calculation scenario in which all possible attributes are given and b) an instantiated model that contains only the attributes requested in the query (and required for further calculations). Thus, calculation scenarios can be created that can be used for various queries. With such an arrangement, a calculation scenario 150 can be created which can be reused by multiple queries even if such queries do not require every attribute specified by the calculation scenario 150.

Every calculation scenario 150 can be uniquely identifiable by a name (e.g., the calculation scenario 150 can be a database object with a unique identifier, etc.). Accordingly, the calculation scenario 150 can be queried in a manner similar to a view in a SQL database. Thus, the query is forwarded to the calculation node 111-114 for the calculation scenario 150 that is marked as the corresponding default node. In addition, a query can be executed on a particular calculation node 111-114 (as specified in the query). Furthermore, nested calculation scenarios can be generated in which one calculation scenario 150 is used as source in another calculation scenario (e.g. via a calculation node 111-114 in this calculation scenario 150). Each calculation node 111-114 can have one or more output tables. One output table can be consumed by several calculation nodes 111-114.

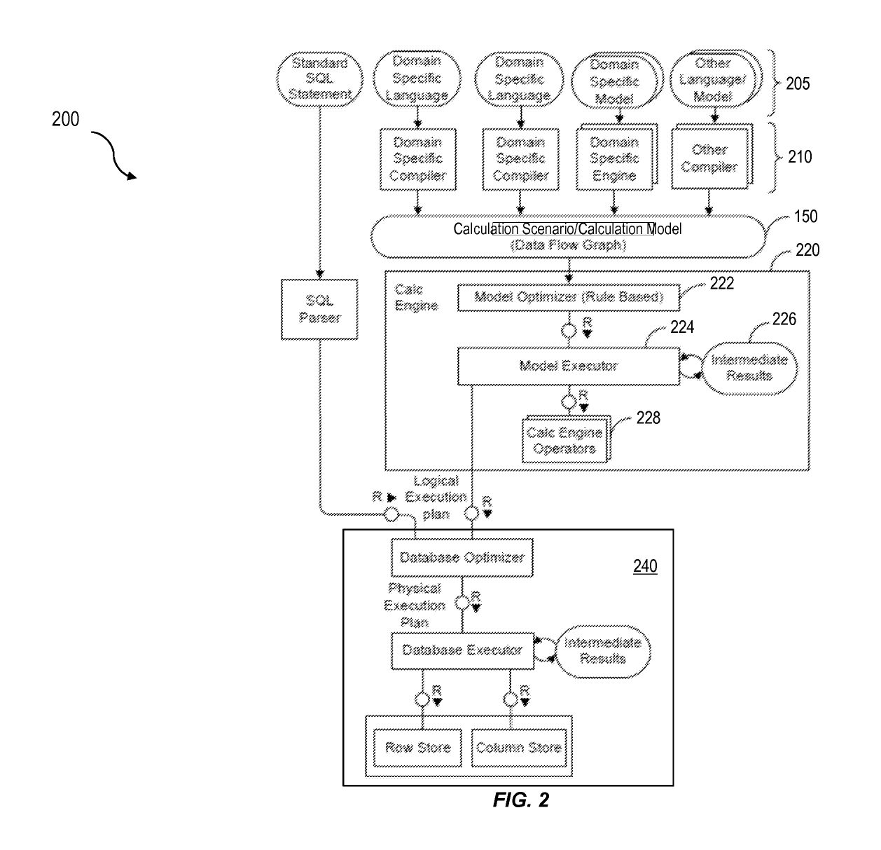

FIG. 2 is a diagram 200 illustrating a sample architecture for request processing and execution control. As shown in FIG. 2, artifacts 205 in different domain specific languages can be translated by their specific compilers 210 into a common representation called a “calculation scenario” 150 (which is also referred to in in FIG. 2 as a calculation model). To achieve enhanced performance, the models and programs written in these languages are executed inside the database server 140. This arrangement eliminates the need to transfer large amounts of data between the database server 140 and a client application 137, which can be executed by an application server 135. Once the different artifacts 205 are compiled into this calculation scenario 215, they can be processed and executed in the same manner. A calculation engine 220 executes the calculation scenarios 215.

A calculation scenario 215 can be a directed acyclic graph with arrows representing data flows and nodes that represent operations. Each node includes a set of inputs and outputs and an operation (or optionally multiple operations) that transforms the inputs into the outputs. In addition to their primary operation, each node can also include a filter condition for filtering the result set. The inputs and the outputs of the operations can be table valued parameters (i.e., user-defined table types that are passed into a procedure or function and that provide an efficient way to pass multiple rows of data to a client application 137 at the application server 135). Inputs can be connected to tables or to the outputs of other nodes. A calculation scenario 215 can support a variety of node types such as (i) nodes for set operations such as projection, aggregation, join, union, minus, intersection, and (ii) SQL nodes that execute a SQL statement which is an attribute of the node. In addition, to enable parallel execution, a calculation scenario 215 can contain split and merge operations. A split operation can be used to partition input tables for subsequent processing steps based on partitioning criteria. Operations between the split and merge operation can then be executed in parallel for the different partitions. Parallel execution can also be performed without split and merge operation such that all nodes on one level can be executed in parallel until the next synchronization point. Split and merge allows for enhanced/automatically generated parallelization. If a user knows that the operations between the split and merge can work on portioned data without changing the result, he or she can use a split. Then, the nodes can be automatically multiplied between split and merge and partition the data.

A calculation scenario 215 can be defined as part of database metadata and invoked multiple times. A calculation scenario 215 can be created, for example, by a SQL statement “CREATE CALCULATION SCENARIO <NAME> USING <XML or JSON>”. Once a calculation scenario 215 is created, it can be queried (e.g., “SELECT A, B, C FROM <scenario name>”, etc.). In some cases, databases can have pre-defined calculation scenarios 215 (default, previously defined by users, etc.). Calculation scenarios 215 can be persisted in a repository (coupled to the database server 140) or in transient scenarios. Calculation scenarios 215 can also be kept in-memory.

Calculation scenarios 215 are more powerful than traditional SQL queries or SQL views for many reasons. One reason is the possibility to define parameterized calculation schemas that are specialized when the actual query is issued. Unlike a SQL view, a calculation scenario 215 does not describe the actual query to be executed. Rather, it describes the structure of the calculation. Further information is supplied when the calculation scenario is executed. This further information can include parameters that represent values (for example in filter conditions). To provide additional flexibility, the operations can optionally also be refined upon invoking the calculation model. For example, at definition time, the calculation scenario 215 may contain an aggregation node containing all attributes. Later, the attributes for grouping can be supplied with the query. This allows having a predefined generic aggregation, with the actual aggregation dimensions supplied at invocation time. The calculation engine 220 can use the actual parameters, attribute list, grouping attributes, and the like supplied with the invocation to instantiate a query specific calculation scenario 215. This instantiated calculation scenario 215 is optimized for the actual query and does not contain attributes, nodes or data flows that are not needed for the specific invocation.

When the calculation engine 220 gets a request to execute a calculation scenario 215, it can first optimize the calculation scenario 215 using a rule based model optimizer 222. Examples for optimizations performed by the model optimizer can include “pushing down” filters and projections so that intermediate results 226 are narrowed down earlier, or the combination of multiple aggregation and join operations into one node. The optimized model can then be executed by a calculation engine model executor 224 (a similar or the same model executor can be used by the database directly in some cases). This includes decisions about parallel execution of operations in the calculation scenario 215. The model executor 224 can invoke the required operators (using, for example, a calculation engine operators module 228) and manage intermediate results. Most of the operators are executed directly in the calculation engine 220 (e.g., creating the union of several intermediate results). The remaining nodes of the calculation scenario 215 (not implemented in the calculation engine 220) can be transformed by the model executor 224 into a set of logical database execution plans. Multiple set operation nodes can be combined into one logical database execution plan if possible.

The calculation scenarios 215 of the calculation engine 220 can be exposed as a special type of database views called calculation views. That means a calculation view can be used in SQL queries and calculation views can be combined with tables and standard views using joins and sub queries. When such a query is executed, the database executor inside the SQL processor needs to invoke the calculation engine 220 to execute the calculation scenario 215 behind the calculation view. In some implementations, the calculation engine 220 and the SQL processor are calling each other: on one hand the calculation engine 220 invokes the SQL processor for executing set operations and SQL nodes and, on the other hand, the SQL processor invokes the calculation engine 220 when executing SQL queries with calculation views.

The attributes of the incoming datasets utilized by the rules of model optimizer 222 can additionally or alternatively be based on an estimated and/or actual amount of memory consumed by the dataset, a number of rows and/or columns in the dataset, and the number of cell values for the dataset, and the like.

A calculation scenario 215 as described herein can include a type of node referred to herein as a semantic node (or sometimes semantic root node). A database modeler can flag the root node (output) in a graphical calculation view to which the queries of the database applications directed as semantic node. This arrangement allows the calculation engine 220 to easily identify those queries and to thereby provide a proper handling of the query in all cases.

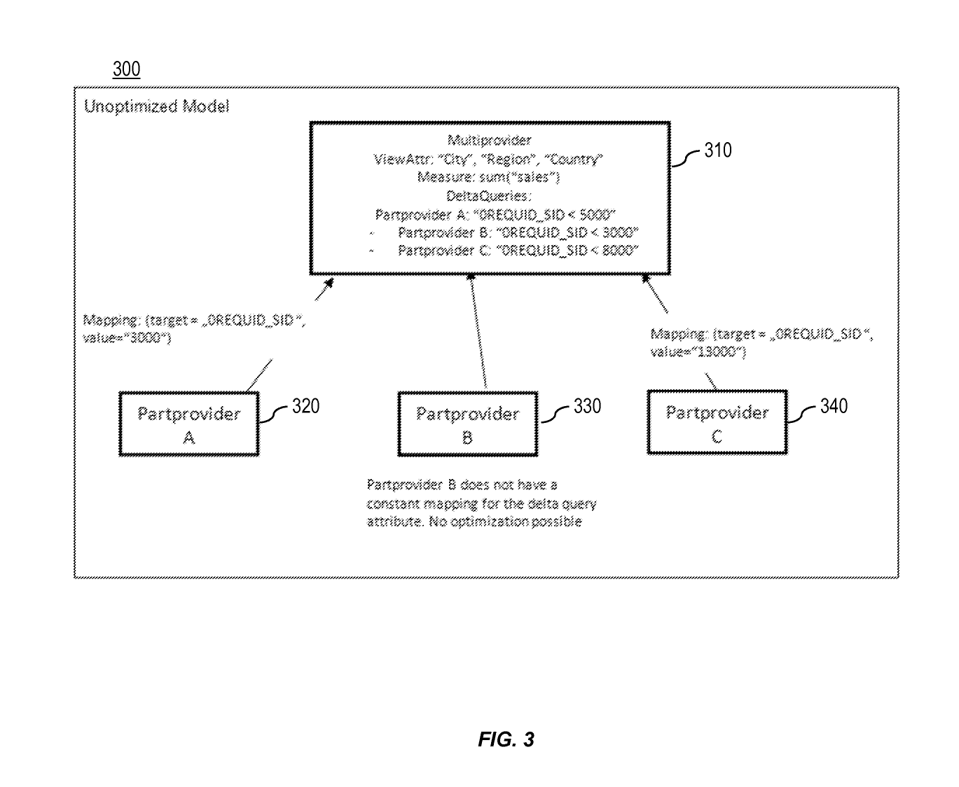

FIG. 3 is a diagram that illustrates an unoptimized model of the calculation scenario 150. Multiprovider 310 contains a plurality of attributes, a measure sum, and a plurality of delta queries. In one embodiment, the plurality of attributes includes a city, a region, and a country. The multiprovider 310 includes three delta queries. Each delta queries corresponds to a query for one of partprovider A 320, partprovider B 330, and partprovider C 340. Delta queries are filter constraints for each partproviders. For example, partprovider A has a delta query with a condition of a mapping value under 5000. Delta query for partprovider B requires a mapping value to be under 3000. Delta query for partprovider C requires a mapping value to be under 8000. In this unoptimized model of the calculation scenario, the delta queries aggregate the partprovider A 320, the partprovider B 330, and the partprovider C 340 for the mapping values every time multiprovider 310 is run. In one embodiment, Partprovider A has a mapping value of a constant value of 3000. Partprovider B does not have a mapping value of a constant value. partprovider C has a mapping value of a constant value of 13000.

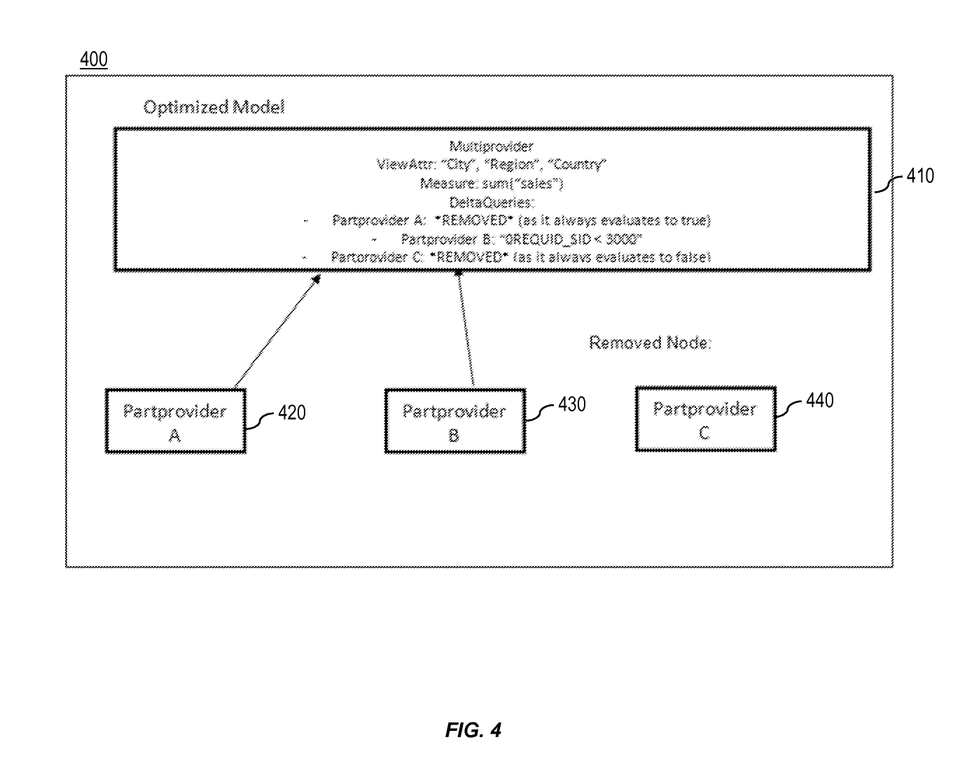

FIG. 4 is a diagram that illustrates an optimized model of the calculation scenario 150. The delta queries of multiprovider 310 are evaluated to determine if any of the delta queries is unnecessary. For example, partprovider A has a delta query with a condition of a mapping value under 5000. Because partprovider A has a mapping value of a constant value of 3000, which is under 5000, the delta query of partprovider A is evaluated to be always “true.” Thus, the delta query of partprovider A is unnecessary and removed. Partprovider B does not have a mapping value of a constant value. Thus, the delta query for partprovider B has to be aggregated every time. Delta query for partprovider C requires a mapping value to be under 8000. Because partprovider C has a mapping value of a constant value of 13000, the delta query of partprovider C is evaluated to be always “false.” Thus, partprovider C is removed from the optimized model and thus the query. No data will be requested from partprovider C. Therefore, the delta queries for partprovider A and partprovider C are determined to be unnecessary and are pruned from the query.

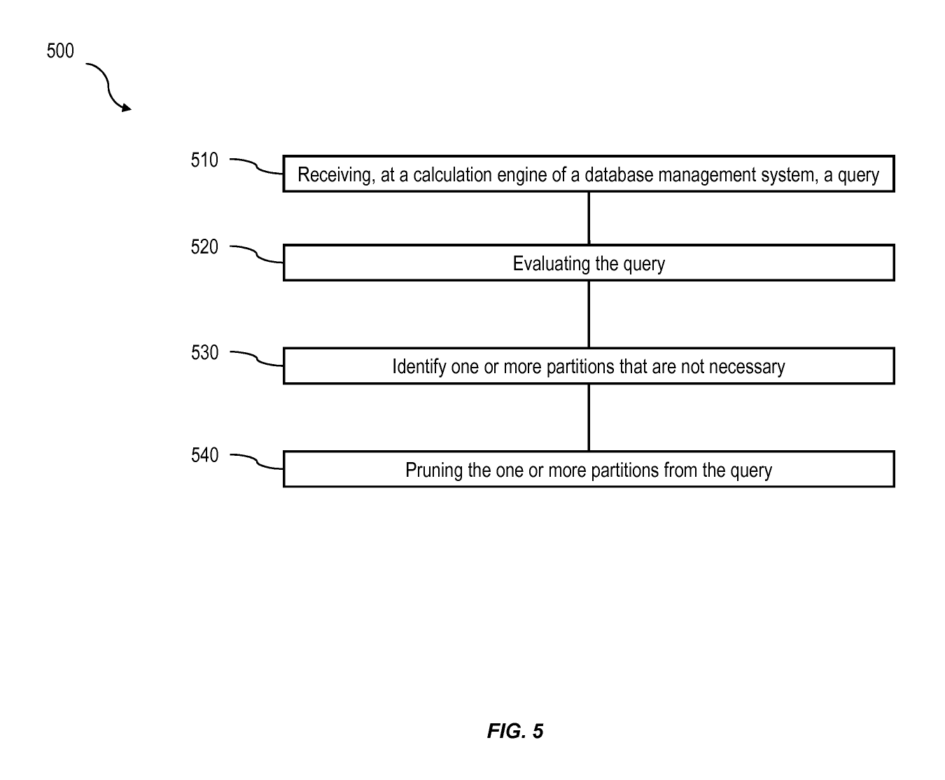

FIG. 5 is a process flow diagram 500 illustrating a method of pruning of table partitions from a calculation scenario for executing a query. At 510, a calculation engine of a database management system receives a calculation scenario. The calculation scenario comprises a query of a multiprovider that comprises a plurality of partitions. In some embodiments, the calculation scenario comprises a plurality of queries. At 520, the calculation engine evaluates the query to identify a partition of the plurality of partitions that is not necessary for responding to the query. The evaluation comprises comparing a mapping value of the partition to a filter constraint. In some embodiments, the calculation engine evaluates the query by determining the mapping value having a constant value that is outside of range specified in the filter constrain of the query. If the result of the comparing is always true, the filter constraint of the one or more partitions are unnecessary and removed. If the result of the comparing is always false, the one or more partitions are not necessary. At 530, the calculation engine prunes the partition from the calculation scenario. The pruning comprises not loading or accessing the partition in the execution of the query.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, at a calculation engine of a database management system, a calculation scenario, the calculation scenario comprising a query of a multiprovider that comprises a plurality of partitions;
evaluating the query to identify a partition of the plurality of partitions that is not necessary for responding to the query, the evaluating comprising comparing a mapping value of the partition to a filter constraint; and
pruning the partition from the calculation scenario, the pruning comprising not loading or accessing the partition in the execution of the query and/or removing the filter constraint for the partition.

2. The method of claim 1, wherein the calculation scenario comprises a plurality of queries.

3. The method of claim 1, wherein the comparing a mapping value of the partition to a filter constraint comprises determining the mapping value having a constant value that is outside of range specified in the filter constrain of the query.

4. The method of claim 1, wherein the filter constraint is removed when the result of the comparing is always true.

5. The method of claim 1, wherein the partition is not necessary when the result of the comparing is always false.

6. A non-transitory computer program product storing instructions which, when executed by at least one hardware data processors, result in operations comprising:
receiving, at a calculation engine of a database management system, a calculation scenario, the calculation scenario comprising a query of a multiprovider that comprises a plurality of partitions;
evaluating the query to identify a partition of the plurality of partitions that is not necessary for responding to the query, the evaluating comprising comparing a mapping value of the partition to a filter constraint; and
pruning the partition from the calculation scenario, the pruning comprising not loading or accessing the partition in the execution of the query and/or removing the filter constraint for the partition.

7. The non-transitory computer program product of claim 6, wherein the calculation scenario comprises a plurality of queries.

8. The non-transitory computer program product of claim 6, wherein the comparing a mapping value of the partition to a filter constraint comprises determining the mapping value having a constant value that is outside of range specified in the filter constrain of the query.

9. The non-transitory computer program product of claim 6, wherein the filter constraint is removed when the result of the comparing is always true.

10. The non-transitory computer program product of claim 6, wherein the partition is not necessary when the result of the comparing is always false.

11. A system comprising:
at least one hardware data processor; and
memory storing instructions which, when executed by the at least one data processor, result in operations comprising:
receiving, at a calculation engine of a database management system, a calculation scenario, the calculation scenario comprising a query of a multiprovider that comprises a plurality of partitions;
evaluating the query to identify a partition of the plurality of partitions that is not necessary for responding to the query, the evaluating comprising comparing a mapping value of the partition to a filter constraint; and
pruning the partition from the calculation scenario, the pruning comprising not loading or accessing the partition in the execution of the query and/or removing the filter constraint for the partition.

12. The system of claim 11, wherein the calculation scenario comprises a plurality of queries.

13. The system of claim 11, wherein the comparing a mapping value of the partition to a filter constraint comprises determining the mapping value having a constant value that is outside of range specified in the filter constrain of the query.

14. The system of claim 11, wherein the filter constraint is removed when the result of the comparing is always true.

15. The system of claim 11, wherein the partition is not necessary when the result of the comparing is always false.
